(19) United States
(12) Patent Application Publication
(10) Pub. No.: US 2012/0306199 A1
(43) Pub. Date: Dec. 6, 2012

(54) TUBULAR COMPONENT FOR HYDROCARBON WELL EXPLORATION

(75) Inventor: Didier DAVID, Ruesnes (FR)

(73) Assignee: VAM DRILLING FRANCE, Cosne Cours sur Loire (FR)

(21) Appl. No.: 13/483,473

(22) Filed: May 30, 2012

(30) Foreign Application Priority Data
May 30, 2011 (FR) 11/54691

(51) Int. Cl. F16L 25/00

(52) U.S. Cl. 285/333

(57) ABSTRACT

The invention concerns a tubular component (2) for the exploration or operation of a hydrocarbon well, comprising a pipe body (24) with an axis of revolution (20) extended at at least one of its ends (25) by a first tool joint (23) provided with a threaded end that can connect the tubular component (2) to another tubular component by makeup, the first tool joint (23) being friction welded to said end (25) of the pipe body (24) in order to define a first weld zone (21), characterized in that the circumferential surface of the tubular component comprises an annular groove (22) extending in the region of the first weld zone.

The invention relates to tubular components used for drilling or operating oil or gas fields. In particular, the invention applies to components used in offshore drill stems or to components used in strings to set casings for offshore wells, or to components used in strings to put down other equipment.

In the context of offshore well drilling, it is necessary to drop the drill stem, constituted by drilling components which are made up together, from the platform on the sea surface to the sea bed where drilling takes place. Once the well is excavated, the wall of the hole has to be consolidated by placing casings into it which are cemented with the wall of the hole. Next, to operate the well, the tubing has to be dropped inside the casing right down to the bottom of the well.

The operations for dropping the drill stem from the platform to the sea bed generally require holding the growing drill stem vertically, clamping one of the components of the drill stem in the rotary table for the time required to make up the additional component with the growing stem. For information, drilling components are very thick, and thus very heavy, tubular components. They are generally already connected in threes when they are used to incrementally increase the length of the drill stem.

Operations aimed at dropping the casing or other equipment require the use each time of a landing string which couples the offshore platform to the well. More precisely, the first component of the growing landing string is connected at one of its ends to the casing or to the drill stem, and is then made up with another component of the growing landing string. During makeup of the growing landing string, the rotary table holds the clamped component. For information, the components of the landing string are already connected (in threes at most) when they are used to incrementally increase the length of the landing string.

It appears that when the drill stem or the casing associated with the growing landing string reaches a substantial length, the total traction on the clamped component reaches several thousand tons. This means that the rotary table has to grip the clamped component very tightly.

For this reason, the components of the drill stem, like the components of the landing string, must have good tensile strength. Furthermore, it is necessary to have a sufficient thickness in the pipe body in order to withstand the clamping force of the rotary table.

For this reason, design rules relating to tubular components prescribe threaded connections and set the thicknesses for the tubes which are resistant to tensile loads and clamping loads. However, drilling components, like the components of the landing strings, include heterogeneities in the type of material of the weld zones between the tool joints and the pipe body, which are characteristic of a heat-affected zone.

The weld between the tool joint and the pipe body, generally produced by friction, modifies the mechanical properties of the component of the landing string or drill string in said weld zone due to the core temperature rise in the weld zone. When the jaws of the rotary table clamp the weld zone, phenomena of erosion or even crack initiation may occur, due to the fact that the jaws deform the circumferential surface of the components by impression.

In a variation, tool joints are known which are attached to the pipe bodies via welds wherein a thread of molten material is deposited between the two elements to be joined. This welding technique is known as “butt-welding”. Documents US 2003-0178472 and WO-2005-009662 describe such components.

Such crack initiation subsequently gives rise to crack propagation when the component is in service. That phenomenon is further amplified when the variation in diameter between the weld zone and the pipe body is not gradual, giving rise to particularly high stress concentrations when the component is bent.

The prior art proposed in document FR 2 714 932 is intended to partially reduce the problem with the sensitivity of the weld zone when it bends by providing bending stress relief grooves above and below the weld zone and on the side of the tool joint. Those grooves act to reduce the rigidity of the base of the tool joint in order to reduce the stress concentration in the region of the weld zone.

A further document, with reference U.S. Pat. No. 5,184,495 recommends making the variation in diameter very gradual between the upset portion of the pipe body which is welded to the tool joint and the nominal diameter of the pipe body. That transitional portion also acts to reduce the stress concentration in the region of the weld zone.

However, those solutions do not prevent the jaws of the rotary table from damaging the circumferential surface in the region of the weld zone.

For this reason, the Applicant proposes protecting the weld zone in order to prevent crack initiation.

More particularly, the invention concerns a tubular component for the exploration or operation of a hydrocarbon well, the component comprising a pipe body with an axis of revolution extended at at least one of its ends by a first tool joint provided with a threaded end that is capable of connecting the tubular component to another tubular component by makeup, the first tool joint being friction welded to said end of the pipe body in order to define a first weld zone, characterized in that the circumferential surface of the tubular component comprises a groove extending in the region of the first weld zone.

The first weld zone may in particular be defined as corresponding to a mechanically and heat-affected zone. In fact, this zone is locally mechanically affected due to the friction welding operation. In particular, a change in the orientation of grain flow of the material can be observed in this mechanically affected zone. This weld zone is also heat-affected due to finishing treatments subsequent to welding.

When the tool joint is connected to the pipe body by friction welding, in general a weld plane P can be defined perpendicular to the axis of the pipe body and corresponding to the interface where the tool joint meets the pipe body. Conventionally, in the field of tubular components for exploration and operation of a hydrocarbon well, the mechanically affected zone corresponds to an annular zone such that the weld plane separates it into two annular demi-zones which are symmetrical with respect to each other relative to that weld plane.

In particular, the zone which is mechanically affected due to the friction welding operation then undergoes several finishing treatments before the groove is formed therein. In particular, the weld line, forming a bead either side of the weld plane, both inside and outside the tubular component, is machined and ground in order to restore a smooth profile both on the inside and outside of the mechanically affected zone. Next, quench and temper operations are carried out using a heating means, in particular an induction heating means, from the inside and the outside in order to restore the mechanical characteristics of this mechanically affected zone so as to define the thermally affected zone. The mechanical properties, in particular resilience and fatigue strength, are modified by this heat treatment.

The heat-affected zone is generally wider than the mechanically affected zone. In particular, the heat-affected zone may be centred on the mechanically affected zone. Thus, the weld zone coincides with the heat-affected zone. As an example, the heat-affected zone may be defined in the axis of the tube by a distance of 10 cm, distributed into two demi-zones each of 5 cm either side of the weld plane.

In accordance with the invention, the groove may correspond to an annular zone defined on the external circumference of the tubular component.

The groove of the invention may be made by machining, with this step being carried out after friction welding and the finishing treatments mentioned above.

Optional characteristics, which may be complementary or substitutional, are set out below.

The groove may be annular and have a curved profile, in particular concave, in longitudinal section along the axis 20 of the component; it is preferably circular with a radius of more than 200 mm.

The groove may be annular and have a constant depth. In this case, the profile of the groove in longitudinal section along the axis 20 of the component may form a hollow with a flat bottom parallel to the axis of the component and connected via borders rising from the flat bottom to the external circumference respectively of the tool joint on the one side and the pipe body on the other side of this flat bottom.

The depth of the groove may be a maximum for a minimum external diameter of the component, OD_{wmin}, at the groove bottom equal to:

OD_{wmin}=ID_{w}+2·wt_{w}·b; where:

ID_{w}: internal diameter of component at right angles to the weld zone (in mm);
wt_{w}: thickness of component in the region of the end of the pipe body (in mm);
b: predetermined and allowed degree of wear of the circumferential surface of the component; as an example, b is strictly less than 1 and more than 0.7, for example equal to 0.85 or 0.8 or even 0.95

The depth of the groove may be a minimum for a maximum external diameter of the component, OD_{wmax}, at the groove bottom equal to:

OD_{wmax}=Dte−2·wt(1−b); where:

Dte: external diameter in the region of the end of the pipe body (in mm);
wt: thickness of component at pipe body (in mm);
b: predetermined and allowed degree of wear of the circumferential surface of the component; as an example, b is strictly less than 1 and more than 0.7, for example equal to 0.8 or 0.85 or even 0.95.
The groove may thus have a depth such that the maximum tolerated wear on the pipe body, a function of the predetermined and allowed degree of wear b, means that constraints on the minimum external diameter tolerated on the tubular component can be respected.
The degree of wear b is equal to 1 for a component that has not ever been used. The degree of wear b corresponds to a maximum tolerance limit determined as a function of the desired longevity of the component and the conditions under which it is intended to be used.

The groove may extend over at least the whole of the weld zone. The groove may extend over an axial distance which is greater than that of the first weld zone. Preferably, the groove may be produced so as to be axially superimposed on the first weld zone. As an example, the groove may be centred on the first weld zone.

The groove may extend over a length L such that:

2·(Dte−OD_{wmax})<L<25.4²/(Dte−OD_{wmax});

preferably:

2·(Dte−OD_{wmax})<L<1/(Dte−OD_{wmax});

where:

Dte: external diameter in the region of the end 25 of the pipe body 24 (in mm);

OD_{wmax}: maximum external diameter of the component at the bottom of the groove (in mm).

The groove may extend over a length L in the range 2 mm to 500 mm.

The groove bottom may be linked to the external circumferential surface of the component by means of chamfers.

The chamfers may be inclined with respect to the axis of the component at an angle of less than 60°, preferably substantially equal to 45°.

The groove bottom may be linked to the chamfers by means of a radius r.

The radius r may be in the range 1.6 to 4.8 mm.

The thickness of the end of the pipe body may be greater than the nominal thickness of the pipe body.

The other end of the pipe body may be welded to a second tool joint in order to define a second weld zone, the circumferential surface of the tubular component comprising a second annular groove extending in the region of the second weld zone.

The tubular component may be a component of a drill stem or a component of a landing string.

The first tool joint may comprise a tubular reinforcing piece welded at one of its ends to the end of the pipe body and welded at the other end to the tool joint, the weld zone defined between the tubular reinforcing piece and the tool joint comprising a third groove.

At its circumferential surface, the tubular component may include a coating apart from over the weld zone or zones, in order to define said groove or grooves.

The present invention will be better understood from the detailed description of several embodiments given by way of non-limiting examples and illustrated in the accompanying drawings, in which:

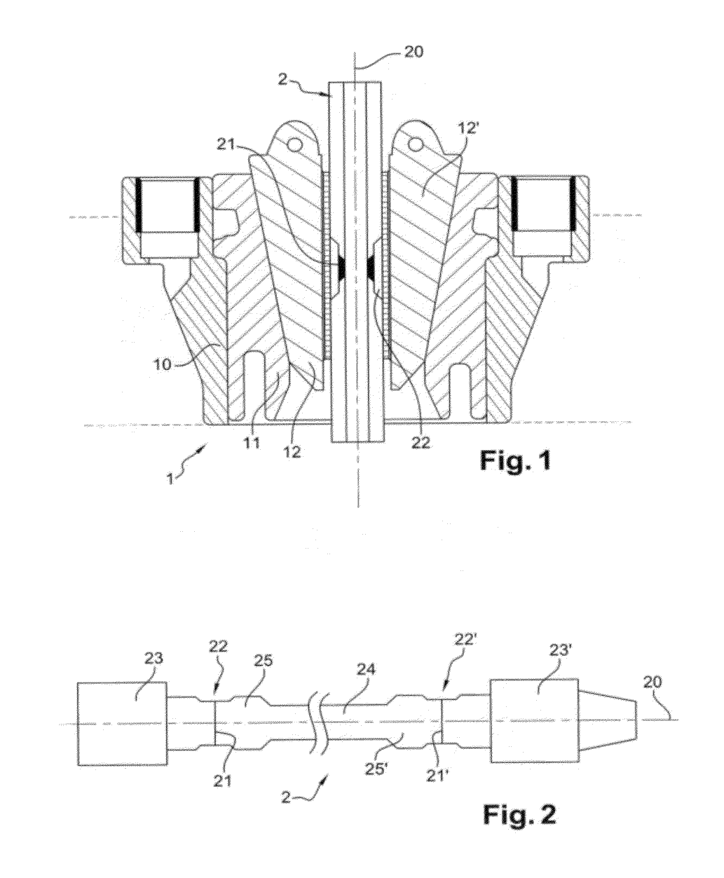

FIG. 1 is a diagrammatic view of a setup for the exploration or operation of hydrocarbon wells;

FIG. 2 is a diagrammatic view of a drill stem or landing string component;

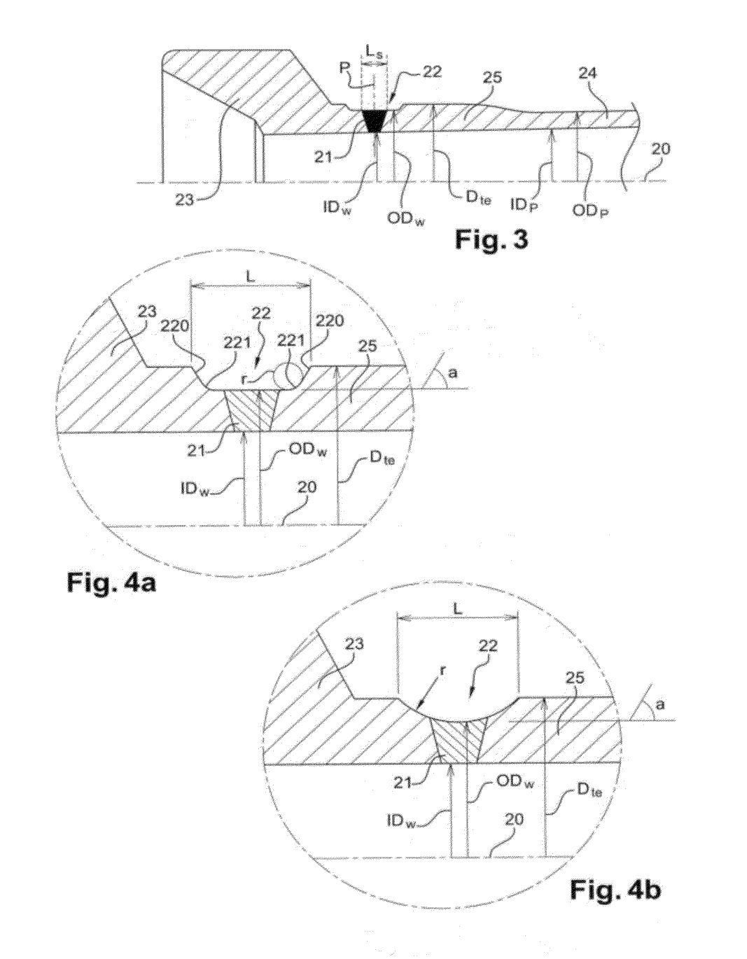

FIGS. 3, 5, 6 are partial diagrammatic views of a component of a drill stem or landing string in accordance with various embodiments of the invention;

FIG. 4a is a detailed partial diagrammatic view of a component of a drill stem or a landing string in accordance with one embodiment;

FIG. 4b is a detailed partial diagrammatic view of a component of a drill stem or a landing string in accordance with another embodiment.

FIG. 1 represents a setup 1 for the exploration or operation of hydrocarbon wells, comprising a rotary table 10, a bowl 11 and clamping jaws 12 and 12′. The rotary table 10 as well as the bowl act to hold the drilling or operating/landing string components 2 vertical and possibly to drive them in rotation. These components 2 are held vertically and fixed by means of the bowl 11 and the jaws 12 and 12′.

FIG. 2 represents a component 2 which may be either a drilling component or an operating string or landing string component. This component, which has an axis of revolution 20, comprises a pipe body 24 which is provided at each of its ends with an upset 25, 25′. Each of the upset ends 25 is welded respectively to a first 23 and a second 23′ tool joint. The tool joints are bodies of revolution provided with a male threading, which is the tool joint 23′, and a female threading, which is the tool joint 23, which act to connect the components together. Thus, there are two weld zones 21 and 21′, generally the results of a friction welding operation. The term “weld zone” means the zone extending either side of the plane of the weld over a distance of approximately 10 cm and coinciding with the heat-affected zone. A first 22 and a second 22′ annular groove respectively is provided on the circumferential surface of the component 2 and more precisely in the region of the weld zones 21a and 21′. The term “groove” means a zone in which the external diameter of the component 2 is reduced with respect to the adjacent zones. Clearly, the invention is not limited to a particular groove geometry.

Preferably and for ease of machining, the groove may be annular in that it represents a body of revolution with respect to the axis 20.

FIG. 3 represents a partial view of a component dedicated to drill stems. The tool joint 23 is attached to the pipe body 24 by means of a welding operation resulting in a welded zone 21. The pipe body 24 comprises an upset end 25 for this purpose. In accordance with design rules, the thickness of the component at the weld zone is greater than the nominal thickness of the pipe body. The calculation of the thicknesses is made conventionally by taking the difference between the external and internal half-diameters, i.e. (OD_{w}−ID_{w})/2 for the thickness of the weld zone 21 before formation of the groove and (ODₚ−IDₚ)/2 for the nominal thickness of the pipe body 24.

FIG. 4a describes a preferred embodiment of the groove 22. A component is seen comprising a weld zone 21 attaching a tool joint 23 to the upset end 25 of a pipe body, not shown in the figure. The annular groove has a groove bottom with a constant depth.

FIG. 4b describes another embodiment showing a component comprising a weld zone 21 attaching a tool joint 23 to the upset end 25 of a pipe body, not shown in the figure. Along a longitudinal section along the axis 20 of the component, the annular groove has a curved profile. This curved profile preferably has the shape of a circular arc, which simplifies machining operations. The radius R of the support circle is preferably selected to be over 200 mm.

Advantageously, the Applicant has established design rules relating to the minimum and maximum external diameter in the groove, i.e. at the weld zone. More precisely, the minimum diameter OD_{wmin} at right angles to the weld and to the bottom of the groove is expressed as follows:

OD_{wmin}=ID_{w}+2·wt_{w}·b,

where:

ID_{w}: internal diameter at right angles to the weld 21 (in mm);

wt_{w}: thickness of component at the upset end 25 of the pipe body 24 (in mm);

b: degree of wear of the circumferential surface used for the component which is permitted, i.e. selected for the design.

This reflects the fact that that the component must have a diameter at the groove bottom at least equal to that which would be obtained if the groove were not present and if the degree of wear were applied to this region, namely if the maximum degree of wear b were reached. This is motivated by the fact that a tensile strength at least equal to that which would be present if the groove were not present has to be guaranteed and if the component had worn at this point. Thus, during the whole of the envisaged period of use of the tubular component, its technical characteristics and its integrity are preserved throughout its service life irrespective of the number of times it is disposed in the clamping jaws 12 and 12′

At the same time, the maximum diameter OD_{wmax} at the weld and the bottom of the groove is expressed as follows:

OD_{wmax}=Dte−2·wt(1−b);

where:

Dte: external diameter in the region of upset end 25 of the pipe body 24 (in mm);

wt: thickness of component in the region of the pipe body 24 (in mm);

b: degree of wear of the circumferential surface used for the component which is permitted, i.e. selected for the design.

This reflects the fact that that the component must have a diameter in the region of the groove that is less than the diameter which is observed for the upset adjacent end 25 once the degree of wear has been applied. The circumferential surface of the component at the weld zone as defined is still less than the remainder of the surface in order to protect the clamping jaws 12, 12′.

Advantageously, the Applicant recommends design rules which dictate that the tensile stresses at the weld zone are similar to those which are exerted in the region of the pipe body after wear of the component. These design rules employ the principle of equal resistance.

The traction in the weld zone is expressed as follows:

T_{w}=π/4·((ID_{w}+2·wt_{w})²−ID_{w}²)·Y_{w}

ID_{w}: internal diameter at right angles to the weld 21;

wt_{w}: thickness of component in the region of the upset end of the pipe body 24;

Y_{w}: minimum elastic limit in the weld zone. In particular, Y_{w} is in the range 517 Mpa to 897 MPa.

The traction in the pipe body is expressed as follows:

Tₚ=π/4·(ODₚ²−IDₚ²)·Yₚ

IDₚ: internal diameter in the pipe body 24;

ODₚ: external diameter in the pipe body 24;

Yₚ: minimum elastic limit in the pipe body 24. In particular, Yₚ is in the range 517 Mpa to 1138 MPa.

Hence, equal resistance in traction of the component is expressed as follows:

(ODₚ²−IDₚ²)·Yₚ=((ID_{w}+2·wt_{w})²−ID_{w}²)·Y_{w}

In general, a predetermined safety coefficient is included to guarantee that the weld zone is more resistant than the pipe body. As an example, this safety coefficient is 1.1, i.e. 10%, such that the following equation is satisfied:

T_{w}>1.1×Tₚ

Advantageously, the Applicant recommends design rules aimed at encompassing the length L of the groove, knowing that the groove has to extend over at least the entire length of the weld zone. The length of the groove L may also be determined in a relative manner, as a proportion of the length Ls, FIG. 3, of the weld zone, the length Ls being the maximum length of the weld zone which coincides with the heat-affected zone, generally observed on the external circumference of the tubular component. In particular, the length L may satisfy the following equation:

L>1.1×Ls

or preferably:

L>1.5×Ls

In the example of FIG. 3, the lengths L and Ls are distributed equally either side of the weld plane P.

The Applicant has established the following relationship:

2·(Dte−OD_{wmax})<L<25.4²/(Dte−OD_{wmax}); preferably:

2·(Dte−OD_{wmax})<L<1/(Dte−OD_{wmax});

where:

Dte: external diameter in the region of the upset end 25 of the pipe body 24 (in mm);

OD_{wmax}: maximum external diameter at right angles to the weld zone 21 (in mm).

Taking into consideration the dimensions currently applied to components, the length of the groove L may preferably be in the range Lₘᵢₙ, 2 mm and Lₘₐₓ, 500 mm, preferably in the range 50 mm to 400 mm, and more preferably in the range 100 mm to 300 mm.

The Applicant recommends connecting the sides 220 of the groove with the circumferential surface of the component by means of chamfers which are inclined with respect to the axis 20 of the component at an angle of less than 60°, preferably of the order of 45°.

Similarly, the chamfers may advantageously be connected to the bottom of the groove by means of a radius r with reference 221, in order to minimize the stress concentration observed in the region of the acute angles. The Applicant uses the following preferred relationship:

1.6<r<4.8mm

By way of example, grooves with differing sizes were provided by the Applicant on landing string components with specific diameters and grades. The results are shown in the table below.

It appears from the table that the performances in the region of the groove were better than those of the pipe body taking into account the minimum and maximum dimensions of the groove.

| | | | Performance of pipe | | Performance of pipe | | | | | | |
|---|---|---|---|---|---|---|---|---|---|---|---|
| | | | body for b = 1 | | body for b = 0.95 | | | | | | |
| Characteristics | | | Limit of | Limit of | Limit of | Geometry and performance of groove for b = 1 | | | | | |
| of pipe body | | | tension in | tension in | tension in | | | | | | Limit of |
| ODₚ | Grade | Wt | pipe body | weld zone | pipe body | Dte | OD_{wmax} | ID_{wmin} | Lₘᵢₙ | Lₘₐₓ | tension |
| mm | MPa | mm | kN | kN | kN | mm | mm | mm | mm | mm | kN |
| 149.23 | 1138 | 19.05 | 8866 | 13195 | 8358 | 149.23 | 147.32 | 73.03 | 10.16 | 127.00 | 9846 |
| 149.23 | 1138 | 20.65 | 9493 | 13042 | 8942 | 149.23 | 147.16 | 66.68 | 10.48 | 123.12 | 10323 |
| 168.28 | 1034 | 19.05 | 10163 | 17651 | 8718 | 168.28 | 166.37 | 85.84 | 9.84 | 98.32 | 13086 |
| 168.28 | 1138 | 20.65 | 10163 | 17651 | 9590 | 168.28 | 166.37 | 85.85 | 9.84 | 98.32 | 13086 |
| 168.28 | 1034 | 20.65 | 10899 | 17655 | 9344 | 168.28 | 166.21 | 86.87 | 10 | 96.75 | 12954 |
| 168.28 | 1138 | 20.65 | 10899 | 17655 | 10278 | 168.28 | 166.21 | 86.87 | 10 | 96.75 | 12954 |
| 168.28 | 1138 | 23.83 | 12304 | 17646 | 11589 | 168.28 | 165.89 | 88.90 | 10.32 | 93.77 | 12688 |

More particularly, the invention concerns drill stem components, which are particularly massive components compared with other components such as operating tubulars. It is known that when the growing drill stem reaches a considerable length, its weight may reach several thousand tonnes. This requires that the rotary table has to provide a very high clamping force.

The invention also more particularly concerns the components which constitute landing strings. These landing strings act to support the casing strings or the tubing strings.

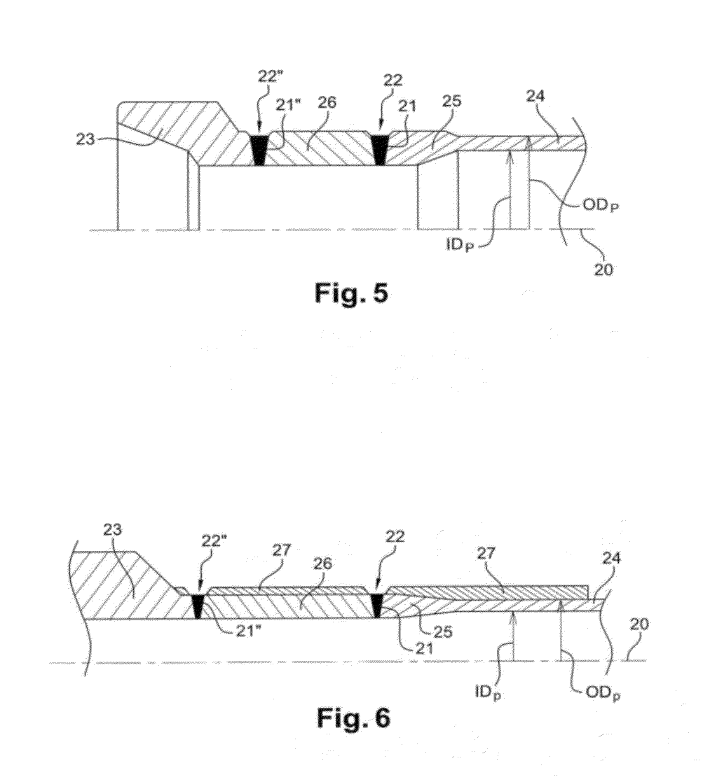

More particularly, the invention concerns reinforced components which can constitute both a drill stem and a landing string. These reinforced components (crush proof landing) are the subject of FIG. 5. These components comprise a first tool joint 23 provided with a tubular reinforcing piece 26 welded at one of its ends to the threaded end of said tool joint and welded at its other end to the end 25 of the pipe body 24. The weld zone 21″ defined between the tubular reinforcing piece 26 and the threaded end of the tool joint 23 comprises a groove 22″. Similarly, the weld zone 21 defined between the tubular reinforcing piece 26 and the upset end 25 of the pipe body 24 comprises a groove 22.

As can be seen in FIG. 6, the tubular component is a reinforced component of the “crush proof landing” type and constitutes a variation of the component shown in FIG. 5. On a portion of its outer circumferential surface, it further comprises a coating 27 except in the region of the weld zone or zones. In this manner, grooves 22 and 22″ can be formed. This variation means on the one hand that a groove in accordance with the invention can be formed and on the other hand, it means that supplemental functions can be incorporated which are inherent to the properties of the coating.

1. A tubular component (2) for the exploration or operation of a hydrocarbon well, comprising a pipe body (24) with an axis of revolution (20) extended at at least one of its ends (25) by a first tool joint (23) provided with a threaded end that is capable of connecting the tubular component (2) to another tubular component by makeup, the first tool joint (23) being friction welded to said end (25) of the pipe body (24) thereby defining a first weld zone (21), characterized in that the circumferential surface of the tubular component comprises a groove (22) extending over the first weld zone.

2. A tubular component according to claim 1, characterized in that the groove is annular and has a curved profile, in longitudinal section along the axis (20) of the component, which is preferably circular with a radius of more than 200 mm.

3. A tubular component according to claim 1, characterized in that the groove is annular and has a constant depth over all or a portion of its depth.

4. A tubular component according to any one of the preceding claims, characterized in that the depth of the groove is a maximum for a minimum external diameter of the component, OD_{wmin}, at the groove bottom equal to:
OD_{wmin}=ID_{w}+2·wt_{w}·b, where:
ID_{w}: internal diameter of component at right angles to the weld zone;
wt_{w}: thickness of component in the region of the end of the pipe body (24);
b: selected degree of wear of the circumferential surface of the component (2).

5. A tubular component according to any one of the preceding claims, characterized in that the depth of the groove is a minimum for a maximum external diameter of the component, OD_{wmax}, at the groove bottom equal to:
OD_{wmax}=Dte−2·wt(1−b); where:
Dte: external diameter in the region of the end (25) of the pipe body (24);
wt: thickness of component in the region of the pipe body (24);
b: selected degree of wear of the circumferential surface of the component (2).

6. A tubular component according to any one of the preceding claims, characterized in that the groove (22) extends over at least the entire weld zone (21).

7. A tubular component according to claim 6, characterized in that the groove (22) extends over a length L such that:
2·(Dte−OD_{wmax})<L<25.4²/(Dte−OD_{wmax}); preferably
2·(Dte−OD_{wmax})<L<1/(Dte−OD_{wmax}); where:
Dte: external diameter in the region of the end (25) of the pipe body (24);
OD_{wmax}: maximum external diameter of the component at the bottom of the groove.

8. A tubular component according to claim 7, characterized in that the groove (22) extends over a length L in the range Lₘᵢₙ, 2 mm, to Lₘₐₓ, 500 mm.

9. A tubular component according to any one of the preceding claims, characterized in that the groove bottom (22) is linked to the circumferential surface of the component by means of chamfers (220).

10. A tubular component according to claim 9, characterized in that the chamfers (220) are inclined with respect to the axis (20) of the component at an angle of less than 60°, preferably substantially equal to 45°.

11. A tubular component according to claim 9 or claim 10, characterized in that groove bottom (22) is linked to the chamfers by means of a radius r.

12. A tubular component according to claim 11, characterized in that the radius r is in the range 1.6 to 4.8 mm.

13. A tubular component according to any one of the preceding claims, characterized in that the thickness of the end (25) of the pipe body (24) is greater than the nominal thickness of the pipe body (24).

14. A tubular component according to any one of the preceding claims, characterized in that the other end (25′) of the pipe body (24) is welded to a second tool joint (23′) defining a second weld zone (21′), the circumferential surface of the tubular component comprising a second annular groove (22′) extending over the second weld zone (21′).

15. A tubular component according to any one of the preceding claims, characterized in that the tubular component is a drill stem component.

16. A tubular component according to claim 15, characterized in that the first tool joint (23) comprises a tubular reinforcing piece (26) welded at one of its ends to the threaded end of said tool joint and welded at its other end to the end (25) of the pipe body (24), the weld zone (21″) defined between the tubular reinforcing piece (26) and the threaded end of the tool joint (23) comprising a third groove (22″).

17. A tubular component according to any one of claims 1 to 14, characterized in that the tubular component is a landing string component.

18. A tubular component according to any one of the preceding claims, characterized in that the tubular component comprises a coating on its circumferential surface which does not overlap the weld zone or zones, in order to define said groove or grooves.
